(19) United States
(12) Patent Application Publication
(10) Pub. No.: US 2008/0106472 A1
(43) Pub. Date: May 8, 2008

(54) Pattern antenna structure

(76) Inventors: Cho-Kang Hsu, Hsinchu (TW); Ming-Tsan Tseng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/594,189

(22) Filed: Nov. 8, 2006

(51) Int. Cl. H01Q 9/04; H01Q 1/36

(52) U.S. Cl. 343/700 MS

(57) ABSTRACT

A pattern antenna structure includes a casing, a PCB, and an antenna unit. The PCB is disposed in the casing. The antenna unit is electrically connected with the PCB, and the antenna unit is disposed on the casing to form a predetermined pattern. Hence, the antenna unit of the present invention is the predetermined pattern exactly, and the predetermined is the antenna unit exactly. Especially for the predetermined pattern applied to a trademark, not only the trademark has an antenna function and a trademark appearance function, but also the trademark has an anti-counterfeit function. In other words, consumers can judge whether a purchase product with the trademark is true via testing whether the trademark has the antenna function or not.

### BACKGROUND OF THE INVENTION

1. Field of the Invention

The present invention relates to a pattern antenna structure, and particularly relates to an antenna being directly manufactured as a pattern (trademark).

2. Description of the Related Art

Due to the development of communication technology, a lot of electronic products that use wireless communication technology have been developed, such as cell phones, wireless Internet devices and personal digital assistants (PDAs), etc. Consumers demand that such wireless communication devices have consistently better and better features and appearance, as well as smaller dimensions so that they are easy to carry around.

For cell phones, the number of receiving frequencies has increased from an original single frequency, to two, to three, and now a fourth. The receiving-signal effect of wireless communication devices is an important index for evaluating wireless communication devices. The antenna apparatus is a key factor to determine the receiving-signal effect of wireless communication devices. Therefore, it is important to develop an antenna apparatus that receives signals effectively and also has a fresh fashionable appearance and a small size.

### SUMMARY OF THE INVENTION

The present invention provides a pattern antenna structure. The pattern antenna structure has an antenna being directly manufactured as a pattern (trademark). Hence, the antenna of the pattern antenna structure not only has a traditional function of receiving and sending signals, but also the antenna can be changed into any various appearances itself. Especially for the predetermined pattern applied to a trademark, not only the trademark has an antenna function and a trademark appearance function, but also the trademark has an anti-counterfeit function. In other words, consumers can judge whether a purchase product with the trademark is true via testing whether the trademark has the antenna function or not.

A first aspect of the invention is a pattern antenna structure, comprising: a casing, a PCB, and an antenna unit. The PCB is disposed in the casing. The antenna unit is electrically connected with the PCB, and the antenna unit is disposed on the casing to form a predetermined pattern.

A second aspect of the invention is a pattern antenna structure, comprising: a casing, a PCB, and an antenna unit. The PCB is disposed in the casing. The antenna unit is electrically connected with the PCB. In addition, one part of the antenna unit is disposed inside the casing, and the other part of the antenna unit is disposed on the casing to form a predetermined pattern.

A third aspect of the invention is a pattern antenna structure, comprising: a casing, a PCB, a first partial pattern, and an antenna unit. The PCB is disposed in the casing. The first partial pattern is disposed on the casing. The antenna unit is electrically connected with the PCB. In addition, the antenna unit is disposed on the casing to form a second partial pattern. Furthermore, the first partial pattern and the second partial pattern are combined together to form a complete predetermined pattern.

A fourth aspect of the invention is a pattern antenna structure, comprising: a casing, a PCB, a first partial pattern, and an antenna unit. The PCB is disposed in the casing. The first partial pattern is disposed on the casing. The antenna unit is electrically connected with the PCB. In addition, one part of the antenna unit is disposed inside the casing, and the other part of the antenna unit is disposed on the casing to form a second partial pattern. Furthermore, the first partial pattern and the second partial pattern are combined together to form a complete predetermined pattern.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a schematic view of a pattern antenna structure according to the first embodiment of the present invention;

FIG. 2 is a first layout schematic view of an antenna unit of a pattern antenna structure according to the first embodiment of the present invention;

FIG. 3 is a second layout schematic view of an antenna unit of a pattern antenna structure according to the first embodiment of the present invention;

FIG. 4 is a third layout schematic view of an antenna unit of a pattern antenna structure according to the first embodiment of the present invention;

FIG. 5 is a schematic view of a pattern antenna structure according to the second embodiment of the present invention;

FIG. 6 is a first layout schematic view of an antenna unit of a pattern antenna structure according to the second embodiment of the present invention;

FIG. 7 is a second layout schematic view of an antenna unit of a pattern antenna structure according to the second embodiment of the present invention;

FIG. 8 is a third layout schematic view of an antenna unit of a pattern antenna structure according to the second embodiment of the present invention;

FIG. 9 is a schematic view of a pattern antenna structure according to the third embodiment of the present invention;

FIG. 10 is a first layout schematic view of an antenna unit of a pattern antenna structure according to the third embodiment of the present invention;

FIG. 11 is a second layout schematic view of an antenna unit of a pattern antenna structure according to the third embodiment of the present invention;

FIG. 12 is a third layout schematic view of an antenna unit of a pattern antenna structure according to the third embodiment of the present invention;

FIG. 13 is a schematic view of a pattern antenna structure according to the fourth embodiment of the present invention;

FIG. 14 is a first layout schematic view of an antenna unit of a pattern antenna structure according to the fourth embodiment of the present invention;

FIG. 15 is a second layout schematic view of an antenna unit of a pattern antenna structure according to the fourth embodiment of the present invention; and

FIG. 16 is a third layout schematic view of an antenna unit of a pattern antenna structure according to the fourth embodiment of the present invention.

### DETAILED DESCRIPTION OF PREFERRED EMBODIMENTS

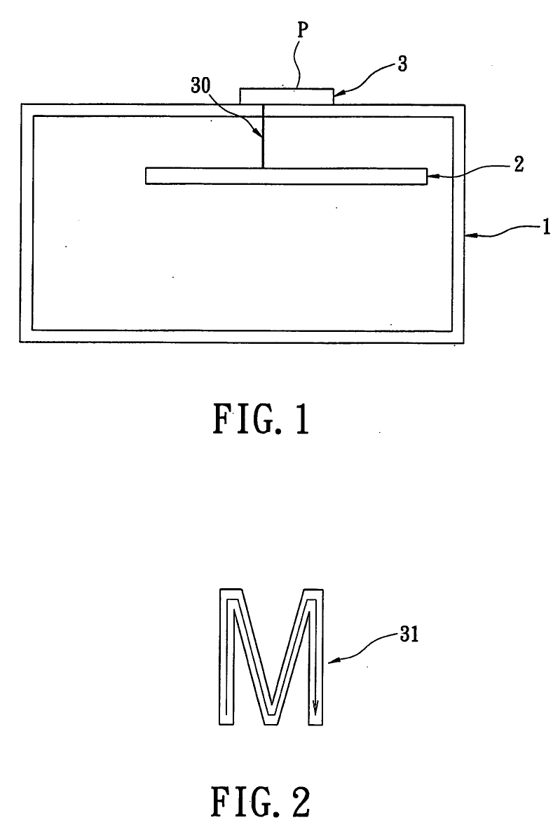

Referring to FIG. 1, the first embodiment of the present invention provides a pattern antenna structure, comprising: a casing 1, a PCB 2, and an antenna unit 3.

The PCB 2 is disposed in the casing 1. The antenna unit 3 has at least one contact point 30, and the antenna unit 3 is electrically connected with the PCB 2 via the at least one contact point 30. Moreover, the antenna unit 3 is disposed on the casing 1 to form a predetermined pattern P. Hence, the predetermined pattern P can be a logo, or any pattern or character. In addition, the antenna unit 3 can also be a projective metal body projected from a surface of the casing 1.

Referring to FIG. 2, for example the predetermined pattern is a character of “M”. The antenna unit 3 is a continuous antenna 31 (as the run of the arrow). Hence, the character of “M” is the antenna 31.

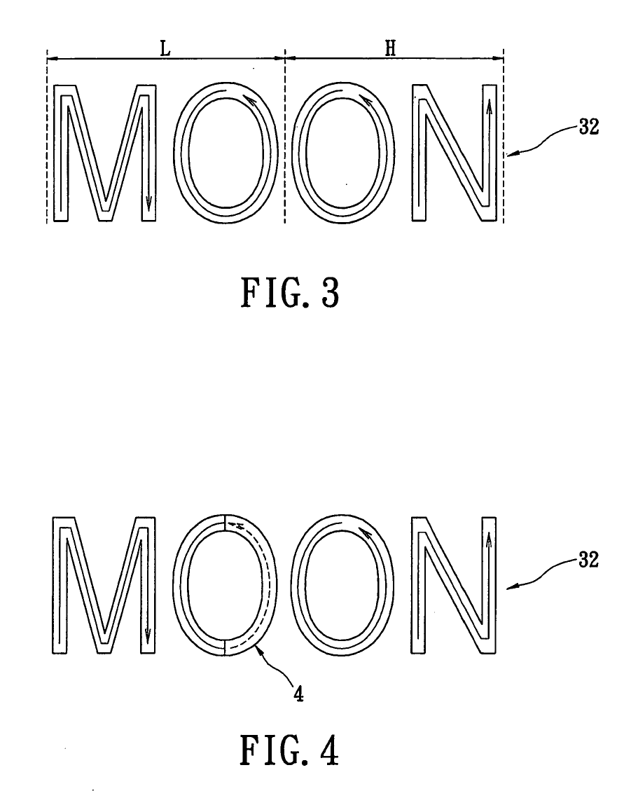

Referring to FIG. 3, for example the predetermined pattern is a word of “MOON”. The antenna unit 3 is composed of a plurality of antennas 32 (as the run of the arrow) that are separated each other. Hence, the word of “MOON” is the antennas 32. Moreover, according to the user's needs, the antennas 32 can be divided into a plurality of different frequency areas. For example, one part of the antennas 32 is to form a low frequency area L, and the other part of the antennas 32 is to form a high frequency area H.

Referring to FIG. 4, the pattern antenna structure of the first embodiment further comprises a filter unit 4 disposed on the antenna unit 3 for filtering a predetermined area that the antenna unit 3 does not need. For example, the predetermined pattern is a word of “MOON”. When one part of the word of “MOON” is covered by the filter unit 4, and the one part of the word of “MOON” is that the antennas 32 of the antenna unit 3 does not need.

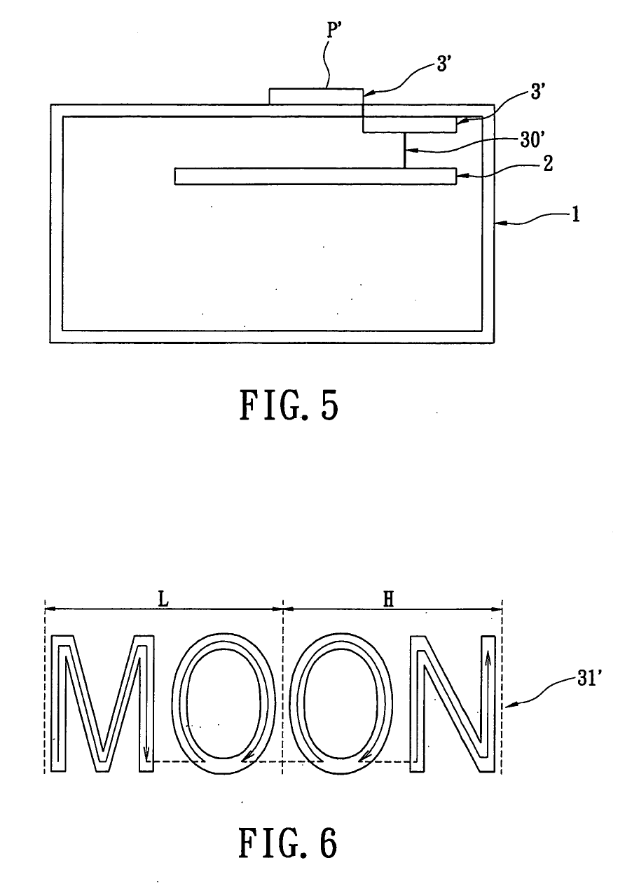

Referring to FIG. 5, the second embodiment of the present invention provides a pattern antenna structure, comprising: a casing 1, a PCB 2, and an antenna unit 3′.

The PCB 2 is disposed in the casing 1. The antenna unit 3′ has at least one contact point 30′, and the antenna unit 3′ is electrically connected with the PCB 2 via the at least one contact point 30′. Moreover, one part of the antenna unit 3′ is disposed inside the casing 1, and the other part of the antenna unit 3′ is disposed on the casing 1 to form a predetermined pattern P′. Hence, the predetermined pattern P′ can be a logo, or any pattern or character. In addition, the antenna unit 3′ can also be a projective metal body projected from a surface of the casing 1.

Referring to FIG. 6, for example the predetermined pattern is a word of “MOON”. The antenna unit 3′ is a continuous antenna 31′ (as the run of the arrow). One part of the antenna 31′ (as the three dotted lines) is not in the range of the word of “MOON”, and the one part of the antenna 31′ is embedded in the casing 1. Hence, the word of “MOON” is the other part of the antenna 31′ (decreasing the three embedded parts of the antenna).

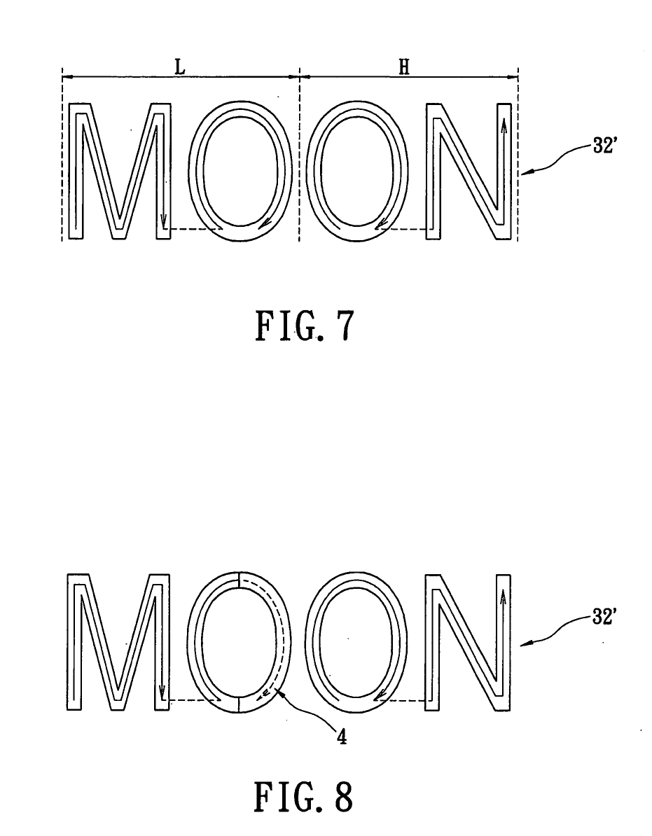

Referring to FIG. 7, for example the predetermined pattern is a word of “MOON”. The antenna unit 3′ is composed of a plurality of antennas 32′ (as the run of the arrow) that are separated each other. One part of the antennas 32′ (as the two dotted lines) is not in the range of the word of “MOON”, and the one part of the antennas 32′ is embedded in the casing 1. Hence, the word of “MOON” is the other part of the antennas 32′ (decreasing the two embedded parts of the antenna). Moreover, according to the user's needs, the antennas 32′ can be divided into a plurality of different frequency areas. For example, one part of the antennas 32′ is to form a low frequency area L, and the other part of the antennas 32′ is to form a high frequency area H.

Referring to FIG. 8, the pattern antenna structure of the second embodiment further comprises a filter unit 4 disposed on the antenna unit 3′ for filtering a predetermined area that the antenna unit 3′ does not need. For example, the predetermined pattern is a word of “MOON”. When one part of the word of “MOON” is covered by the filter unit 4, and the one part of the word of “MOON” is that the antennas 32′ of the antenna unit 3′ does not need.

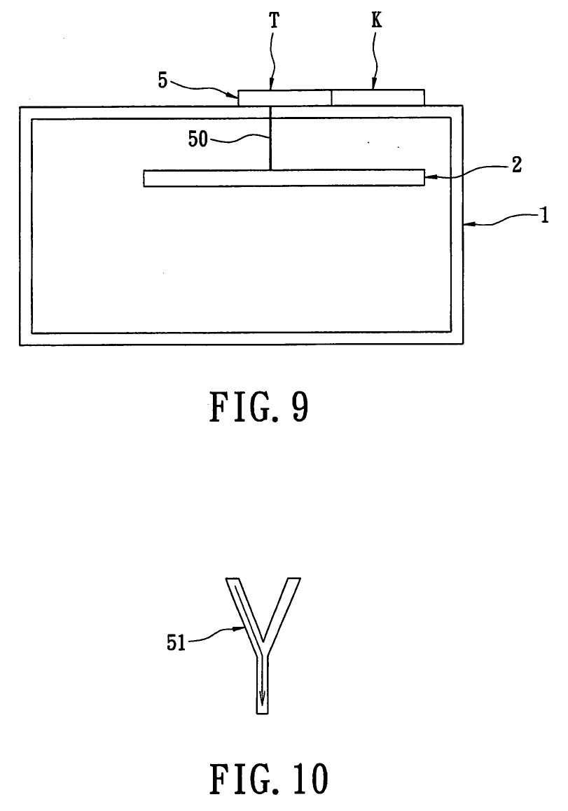

Referring to FIG. 9, the third embodiment of the present invention provides a pattern antenna structure, comprising: a casing 1, a PCB 2, a first partial pattern K, and an antenna unit 5.

The PCB 2 is disposed in the casing 1. The antenna unit 5 has at least one contact point 50, and the antenna unit 5 is electrically connected with the PCB 2 via the at least one contact point 50. Moreover, the first partial pattern K is disposed on the casing 1. In addition, the antenna unit 5 is disposed on the casing 1 to form a second partial pattern T. Furthermore, the first partial pattern K and the second partial pattern T are combined together to form a complete predetermined pattern. Hence, the complete predetermined pattern (K+T) can be a logo, or any pattern or character. In addition, the first partial pattern K is a projective nonmetal body, and the second partial pattern T is a projective metal body. In other words, the antenna unit 5 can also be a projective metal body projected from a surface of the casing 1.

Referring to FIG. 10, for example the predetermined pattern is a character of “Y”. The antenna unit 5 is a continuous antenna 51 (as the run of the arrow). One part of the character of “Y” (such as the first partial pattern K) is not in the range of the antenna 51. Hence, the one part of the character of “Y” and the antenna 51 (such as the second partial pattern T) are combined together to form the character of “Y”.

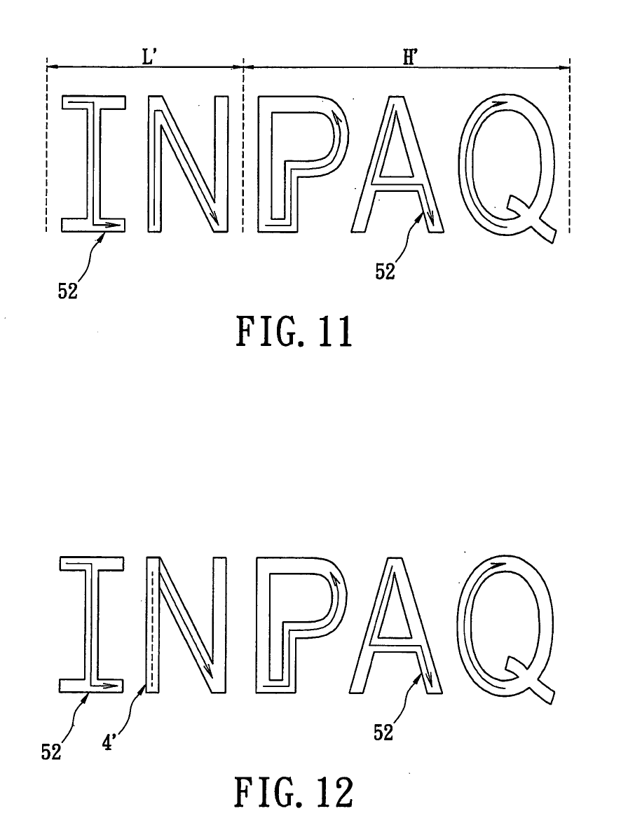

Referring to FIG. 11, for example the predetermined pattern is a word of “INPAQ”. The antenna unit 5 is composed of a plurality of antennas 52 (as the run of the arrow) that are separated each other. One part of the word of “INPAQ” (such as the first partial pattern K) is not in the range of the antennas 52. Hence, the one part of the word of “INPAQ” and the antennas 52 (such as the second partial pattern T) are combined together to form the word of “INPAQ”. Moreover, according to the user's needs, the antennas 52 can be divided into a plurality of different frequency areas. For example, one part of the antennas 52 is to form a low frequency area L′, and the other part of the antennas 52 is to form a high frequency area H′.

Referring to FIG. 12, the pattern antenna structure of the third embodiment further comprises a filter unit 4′ disposed on the antenna unit 5 for filtering a predetermined area that the antenna unit 5 does not need. For example, the predetermined pattern is a word of “INPAQ”. When one part of the word of “INPAQ” is covered by the filter unit 4′, and the one part of the word of “INPAQ” is that the antennas 52 of the antenna unit 5 does not need.

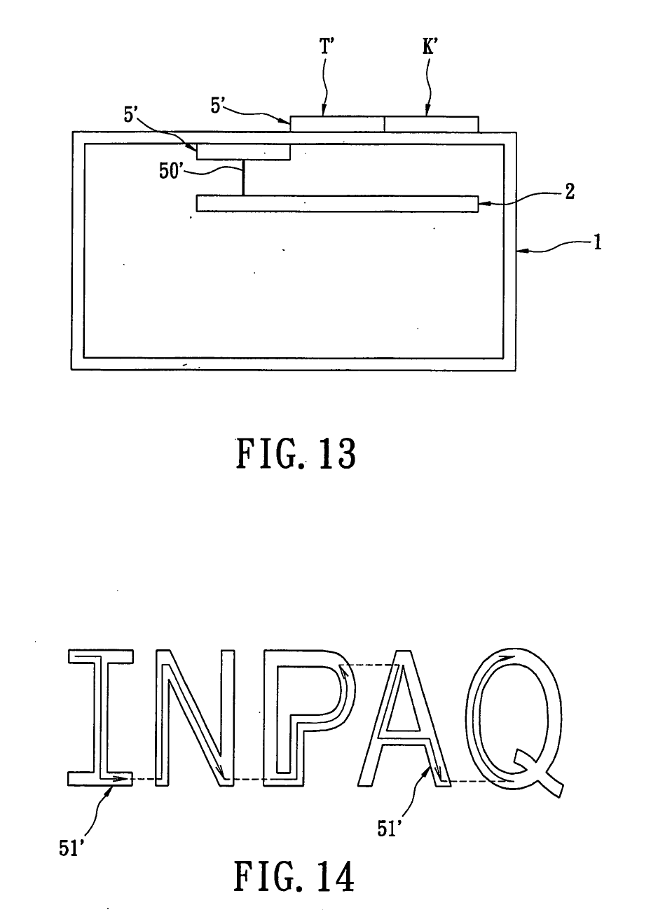

Referring to FIG. 13, the fourth embodiment of the present invention provides a pattern antenna structure, comprising: a casing 1, a PCB 2, a first partial pattern K′, and an antenna unit 5′.

The PCB 2 is disposed in the casing 1. The antenna unit 5′ has at least one contact point 50′, and the antenna unit 5′ is electrically connected with the PCB 2 via the at least one contact point 50′. Moreover, the first partial pattern K′ is disposed on the casing 1. In addition, one part of the antenna unit 5′ is disposed inside the casing 1, and the other part of the antenna unit 5′ is disposed on the casing 1 to form a second partial pattern T′. Furthermore, the first partial pattern K′ and the second partial pattern T′ are combined together to form a complete predetermined pattern. Hence, the complete predetermined pattern (K′+T′) can be a logo, or any pattern or character. In addition, the first partial pattern K′ is a projective nonmetal body, and the second partial pattern T′ is a projective metal body. In other words, the antenna unit 5′ can also be a projective metal body projected from a surface of the casing 1.

Referring to FIG. 14, for example the predetermined pattern is a word of “INPAQ”. The antenna unit 5′ is a continuous antenna 51′ (as the run of the arrow). One part of the antenna 51′ (as the four dotted lines) is not in the range of the word of “INPAQ”, and the one part of the antenna 51′ is embedded in the casing 1. Hence, the one part of the antenna 51′ (such as the first partial pattern K′) and the other part of the antenna 51′ (such as the second partial pattern T′) are combined together to form the word of “INPAQ”.

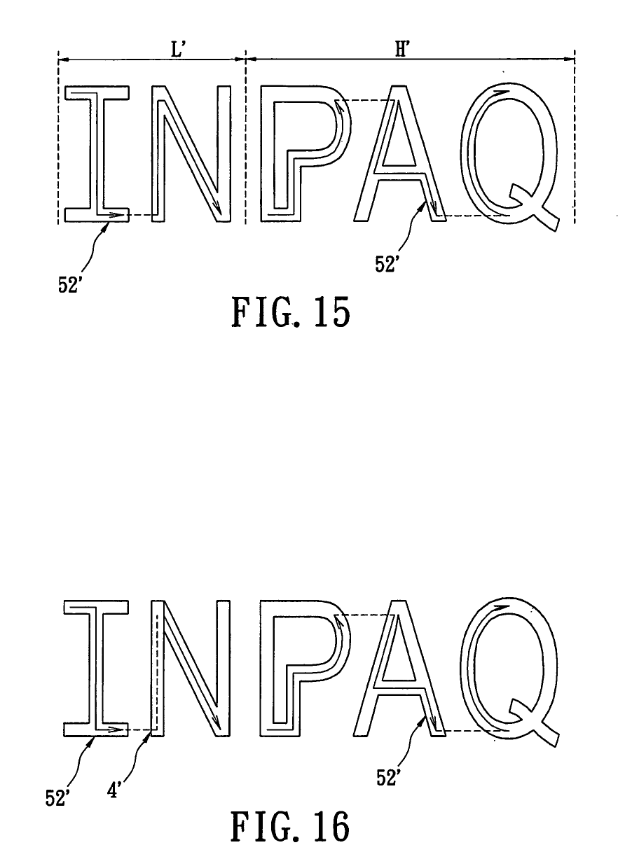

Referring to FIG. 15, for example the predetermined pattern is a word of “INPAQ”. The antenna unit 5′ is composed of a plurality of antennas 52′ (as the run of the arrow) that are separated each other. One part of the antennas 52′ (as the three dotted lines) is not in the range of the word of “INPAQ”, and the one part of the antennas 52′ is embedded in the casing 1. In addition, one part of the word of “INPAQ” (such as the first partial pattern K′) is not in the range of the antennas 52′. Hence, the one part of the word of “INPAQ” and the other part of the antennas 52′ (such as the second partial pattern T′) are combined together to form the word of “INPAQ”. Moreover, according to the user's needs, the antennas 52′ can be divided into a plurality of different frequency areas. For example, one part of the antennas 52′ is to form a low frequency area L′, and the other part of the antennas 52′ is to form a high frequency area H′.

Referring to FIG. 16, the pattern antenna structure of the fourth embodiment further comprises a filter unit 4′ disposed on the antenna unit 5′ for filtering a predetermined area that the antenna unit 5′ does not need. For example, the predetermined pattern is a word of “INPAQ”. When one part of the word of “INPAQ” is covered by the filter unit 4′, and the one part of the word of “INPAQ” is that the antennas 52′ of the antenna unit 5′ does not need.

Furthermore, in above-mentioned embodiments the antenna unit can be a single-layer or multi-layer antenna.

In conclusion, the pattern antenna structure of the present invention has an antenna being directly manufactured as a pattern (trademark). Hence, the antenna of the pattern antenna structure not only has a traditional function of receiving and sending signals, but also the antenna can be changed into any various appearances itself. Especially for the predetermined pattern applied to a trademark, not only the trademark has an antenna function and a trademark appearance function, but also the trademark has an anti-counterfeit function. In other words, consumers can judge whether a purchase product with the trademark is true via testing whether the trademark has the antenna function or not.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A pattern antenna structure, comprising:
a casing;
a PCB disposed in the casing; and
an antenna unit electrically connected with the PCB, wherein the antenna unit is disposed on the casing to form a predetermined pattern.

2. The pattern antenna structure as claimed in claim 1, wherein the predetermined pattern is a logo.

3. The pattern antenna structure as claimed in claim 1, wherein the antenna unit is a projective metal body.

4. The pattern antenna structure as claimed in claim 1, wherein the antenna unit has at least one contact point, and the antenna unit is electrically connected with the PCB via the at least one contact point.

5. The pattern antenna structure as claimed in claim 1, wherein the antenna unit is a multi-layer antenna.

6. The pattern antenna structure as claimed in claim 1, wherein the antenna unit is a continuous antenna.

7. The pattern antenna structure as claimed in claim 1, wherein the antenna unit is composed of a plurality of antennas that are separated each other.

8. The pattern antenna structure as claimed in claim 7, wherein one part of the antennas is to form a low frequency area, and the other part of the antennas is to form a high frequency area.

9. The pattern antenna structure as claimed in claim 7, wherein the antennas is divided into a plurality of different frequency areas.

10. The pattern antenna structure as claimed in claim 1, further comprising a filter unit disposed on the antenna unit for filtering a predetermined area that the antenna unit does not need.

11. A pattern antenna structure, comprising:
a casing;
a PCB disposed in the casing; and
an antenna unit electrically connected with the PCB, wherein one part of the antenna unit is disposed inside the casing, and the other part of the antenna unit is disposed on the casing to form a predetermined pattern.

12. The pattern antenna structure as claimed in claim 11, wherein the predetermined pattern is a logo.

13. The pattern antenna structure as claimed in claim 11, wherein the antenna unit is a projective metal body.

14. The pattern antenna structure as claimed in claim 11, wherein the antenna unit has at least one contact point, and the antenna unit is electrically connected with the PCB via the at least one contact point.

15. The pattern antenna structure as claimed in claim 11, wherein the antenna unit is a multi-layer antenna.

16. The pattern antenna structure as claimed in claim 11, wherein the antenna unit is a continuous antenna.

17. The pattern antenna structure as claimed in claim 11, wherein the antenna unit is composed of a plurality of antennas that are separated each other.

18. The pattern antenna structure as claimed in claim 17, wherein one part of the antennas is to form a low frequency area, and the other part of the antennas is to form a high frequency area.

19. The pattern antenna structure as claimed in claim 17, wherein the antennas is divided into a plurality of different frequency areas.

20. The pattern antenna structure as claimed in claim 11, further comprising a filter unit disposed on the antenna unit for filtering a predetermined area that the antenna unit does not need.

21. A pattern antenna structure, comprising:
a casing;
a PCB disposed in the casing;
a first partial pattern disposed on the casing; and
an antenna unit electrically connected with the PCB, wherein the antenna unit is disposed on the casing to form a second partial pattern;
wherein the first partial pattern and the second partial pattern are combined together to form a complete predetermined pattern.

22. The pattern antenna structure as claimed in claim 21, wherein the complete predetermined pattern is a logo.

23. The pattern antenna structure as claimed in claim 21, wherein the first partial pattern is a projective nonmetal body.

24. The pattern antenna structure as claimed in claim 21, wherein the second partial pattern is a projective metal body.

25. The pattern antenna structure as claimed in claim 21, wherein the antenna unit has at least one contact point, and the antenna unit is electrically connected with the PCB via the at least one contact point.

26. The pattern antenna structure as claimed in claim 21, wherein the antenna unit is a multi-layer antenna.

27. The pattern antenna structure as claimed in claim 21, wherein the antenna unit is a continuous antenna.

28. The pattern antenna structure as claimed in claim 21, wherein the antenna unit is composed of a plurality of antennas that are separated each other.

29. The pattern antenna structure as claimed in claim 28, wherein one part of the antennas is to form a low frequency area, and the other part of the antennas is to form a high frequency area.

30. The pattern antenna structure as claimed in claim 28, wherein the antennas is divided into a plurality of different frequency areas.

31. The pattern antenna structure as claimed in claim 21, further comprising a filter unit disposed on the antenna unit for filtering a predetermined area that the antenna unit does not need.

32. A pattern antenna structure, comprising:
a casing;
a PCB disposed in the casing;
a first partial pattern disposed on the casing; and
an antenna unit electrically connected with the PCB, wherein one part of the antenna unit is disposed inside the casing, and the other part of the antenna unit is disposed on the casing to form a second partial pattern;
wherein the first partial pattern and the second partial pattern are combined together to form a complete predetermined pattern.

33. The pattern antenna structure as claimed in claim 32, wherein the complete predetermined pattern is a logo.

34. The pattern antenna structure as claimed in claim 32, wherein the first partial pattern is a projective nonmetal body.

35. The pattern antenna structure as claimed in claim 32, wherein the second partial pattern is a projective metal body.

36. The pattern antenna structure as claimed in claim 32, wherein the antenna unit has at least one contact point, and the antenna unit is electrically connected with the PCB via the at least one contact point.

37. The pattern antenna structure as claimed in claim 32, wherein the antenna unit is a multi-layer antenna.

38. The pattern antenna structure as claimed in claim 32, wherein the antenna unit is a continuous antenna.

39. The pattern antenna structure as claimed in claim 32, wherein the antenna unit is composed of a plurality of antennas that are separated each other.

40. The pattern antenna structure as claimed in claim 39, wherein one part of the antennas is to form a low frequency area, and the other part of the antennas is to form a high frequency area.

41. The pattern antenna structure as claimed in claim 39, wherein the antennas is divided into a plurality of different frequency areas.

42. The pattern antenna structure as claimed in claim 32, further comprising a filter unit disposed on the antenna unit for filtering a predetermined area that the antenna unit does not need.
